(19) United States
(12) Patent Application Publication
(10) Pub. No.: US 2009/0195384 A1
(43) Pub. Date: Aug. 6, 2009

(54) SYSTEM AND METHOD FOR INVENTORY MANAGEMENT

(75) Inventor: Soroush Amidi, Montreal (CA)

Correspondence Address: Anthony Miologos;Honeywell International Inc., 101 Columbia Road, PO BOX 2245, Morristown, NJ, 07962, US

(73) Assignee: Honeywell International Inc., Morristown, NJ (US)

(21) Appl. No.: 12/024,267

(22) Filed: Feb. 1, 2008

(51) Int. Cl. G08B 13/14; H04Q 5/22

(52) U.S. Cl. 340/568.1; 340/10.1

(57) ABSTRACT

A method includes scanning an asset label on an asset, using a scanner, to determine an asset identifier. The method also includes determining a current location of the scanner. The method also includes storing an asset location record including the current location of the scanner. The current location of the scanner is used as a location of the asset identified by the asset identifier. A scanner includes a barcode reader or a radio frequency identification (RFID) scanner, configured to receive an asset identifier by scanning an asset label of an asset. The scanner also includes a locator configured to determine a current location of the scanner. The scanner also includes a storage configured to store the asset identifier and the current location as an asset location record.

### TECHNICAL FIELD

This disclosure relates generally to inventory management systems and more specifically to a system and method for inventory management and asset location.

### BACKGROUND

Inventory management is important for any business. Managing inventory can be particularly difficult in areas such as a laydown yard or a container yard where materials or containers are deposited and stored over a large area.

### SUMMARY

This disclosure provides a system and method for inventory management.

In a first embodiment, a method includes scanning an asset label on an asset, using a scanner, to determine an asset identifier. The method also includes determining a current location of the scanner. The method also includes storing an asset location record including the current location of the scanner. The current location of the scanner is used as a location of the asset identified by the asset identifier.

In a second embodiment, a scanner includes a barcode reader or a radio frequency identification (RFID) scanner, configured to receive an asset identifier by scanning an asset label of an asset. The scanner also includes a locator configured to determine a current location of the scanner. The scanner also includes a storage configured to store the asset identifier and the current location as an asset location record.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 is a block diagram of an example inventory management system according to one embodiment of this disclosure;

FIG. 2 depicts an example block diagram of a use of a system as disclosed;

FIG. 3 illustrates an example method for providing inventory management according to one embodiment of this disclosure.

### DETAILED DESCRIPTION

Managing inventory in locations such as laydown yards and container yards is very difficult. Millions of dollars of inventory are lost or misplaced during constructions or inventory movement. Customers are looking for a solution that will allow construction and shipping companies to improve their inventory management.

Various embodiments include integrating various pieces of hardware and software together. Disclosed systems and methods provide real-time location of assets stored in a warehouse, laydown yard, container yard, or similar location, generically referred to herein as the storage area.

Some techniques attempt to manage inventory using readers installed across the field to read signals sent by the assets, such as signals emitted by the active radio-frequency identification (RFID) tags. Unfortunately, active RFID tags are generally too expensive to be installed on each product or even on the pallet or container. Passive RFID, which is the cheapest RF-based technology, does not work well in harsh environments and has limited range.

According to disclosed embodiments, instead of trying to locate the assets directly, the system tracks the location of a handheld scanner and associates the current location of the handheld scanner with the assets that are being scanned. The current location of the handheld scanner can be obtained either using global positioning (GPS) techniques, using various location techniques such as Time Difference of Arrival (TDOA), Received Signal Strength Indicator (RSSI), Time of Arrival (TOA) using different RF communications (WiFi, proprietary), or using other known techniques.

The location of the handheld scanner is associated with an asset at scan time when the asset is scanned for storage. The information is then stored in the inventory management system.

According to disclosed embodiments, instead of trying to track assets using active RFID or other expensive RF-based ways, the location of assets can be recording when they are scanned, even during a standard inventory scan. While various implementations would not allow real-time location information updating, the system allows users to quickly know where the object was last stored. If the object is no longer at the same location, then someone has moved it without following the process.

When an asset is stored in a particular location in the storage area, the asset or pallet is scanned using the handheld scanner. The handheld can scan the asset by reading a bar code, reading a passive/active RFID tag, by manual entry of an asset identifier, or other means for uniquely identifying the asset. When scanned, the location of the handheld is automatically associated with the asset.

In some embodiments, the information is then sent to an inventory location system, which can be implemented, for example, using a system such as the INSTANT LOCATION SYSTEM by HONEYWELL INTERNATIONAL INC. This information will be available to any inventory manager via an interface and can be made available to users.

The location of an asset can also be stored directly into the inventory manager. Various embodiments can include hardware, location technology, software that is capable of associating the location of the handheld with an asset at scanned time, an inventory manager and/or location management system, as described in more detail below.

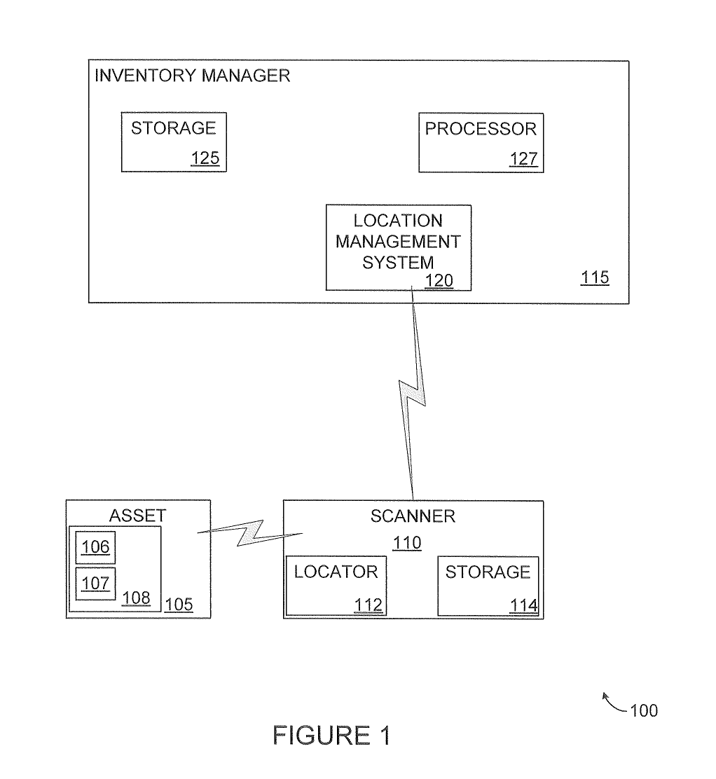

FIG. 1 is a block diagram of an example inventory management system 100 according to one embodiment of this disclosure. The embodiment of the inventory management system 100 shown in FIG. 1 is for illustration only. Other embodiments of the inventory management system 100 may be used without departing from the scope of this disclosure.

As illustrated in FIG. 1, inventory management system 100 includes at least one asset 105, which can include an RFID tag 106 or barcode 107, a human readable label (not shown), or other machine- or human-readable label, all of which are generically referred to herein as the asset label 108. Asset label 108 includes an asset identifier that can uniquely identify the specific asset from other assets in the storage area.

Inventory management system 100 also includes scanner 110, configured to scan the asset label. Scanner 110 includes storage 114 and locator 112 and is configured to communicate with inventory manager 115.

Locator 112 can be a global positioning system (GPS) locator, an assisted GPS locator, a WiFi-based locator, or other known device for accurately determining the location of the scanner 110. Storage 114 is configured to store location data, asset identification data, scanner program data, times and dates, and other data.

Inventory manager 115 is implemented as a data processing system, and includes a processor 127 and a storage 125 capable of storing location data, asset identification data, program data, times and dates, and other data. Inventory manager 115 may include the functions of location management system 120, or location management system 120 can be implemented as a separate data processing system.

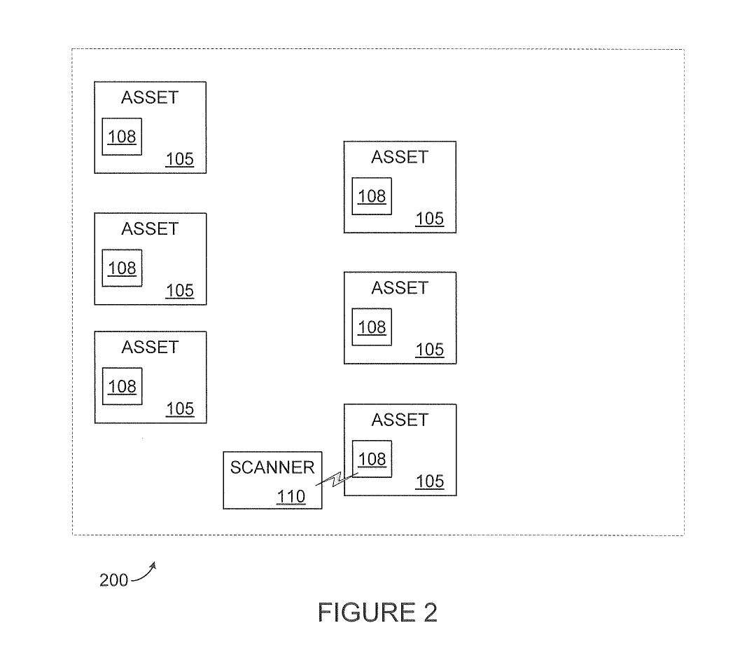

FIG. 2 depicts an example block diagram of a use of a system as disclosed. Storage area 200 stores a plurality of assets 105, each having an asset label 108 that includes an asset identifier. Scanner 110 passes among the assets 105, scanning each asset label 108 to read its asset identifier, and stores each asset identifier, the current location of the scanner 110 as determined by locator 112, and the time and date of the scan. The scanning process can be manual, e.g., by a user passing among the assets 105 and scanning each one, or automated, by an automated scanner passing by or over each asset 105 to perform the scan.

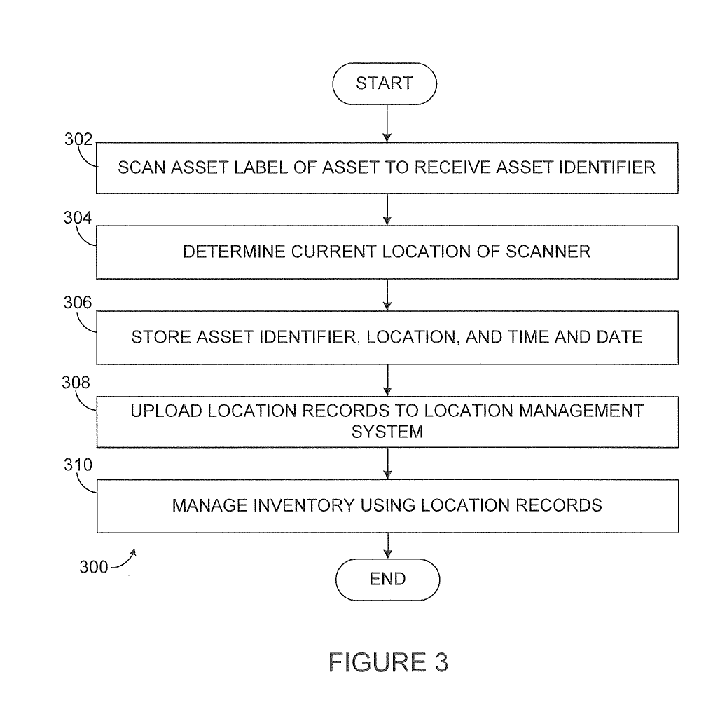

FIG. 3 illustrates an example method 300 for providing inventory management according to one embodiment of this disclosure. The embodiment of the method 300 shown in FIG. 3 is for illustration only. Other embodiments of the method 300 may be used without departing from the scope of this disclosure. Various steps in method 300 need not be performed in the order listed unless specifically so stated. Indeed, some steps may be performed concurrently or in reverse order.

In step 302, scanner 110 scans the asset label 108 of asset 105 to receive an asset identifier. As described above, this may be a barcode scan, an RFID scan, or even a manual entry of the asset identifier.

In step 304, scanner 110 determines the current location of scanner 110 using locator 112. The location may be any specific location identifier, such as geographic coordinates or Cartesian coordinates within the storage area 200. The current location of the scanner is then considered the effective location of the asset.

In step 306, scanner 110 stores the asset identifier, current location, and the time and date of the scan in storage 114. In some embodiments, these are stored together as a single asset location record for the particular asset 105.

Note that in a typical process, steps 302-306 are performed repeatedly to scan and store states for multiple asset 105.

In step 308, the scanner 110 communicates with location management system 120 (whether as a standalone system or as a part of inventory manager 115) to upload the stored location records to location management system 120. This communication can be wired or wireless and can be either synchronous or asynchronous, i.e., the data can be uploaded automatically to the inventory management when a live communication link exists between scanner and database, using either a wireless or wired connection, such as through a docking station. The asset location records are stored in storage 125 and are accessible to location management system 120 and inventory manager 115.

In step 310, inventory manager 115 manages the inventory of assets 105 according to the asset location records stored in storage 125.

In some embodiments, various functions described above are implemented or supported by a computer program that is formed from computer readable program code and that is embodied in a computer useable medium. The phrase “computer readable program code” includes any type of computer code, including source code, object code, and executable code. The phrase “computer useable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The term “application” refers to one or more computer programs, sets of instructions, procedures, functions, objects, classes, instances, or related data adapted for implementation in a suitable computer language. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
scanning an asset label on an asset, using a scanner, to determine an asset identifier;
determining a current location of the scanner; and
storing an asset location record including the current location of the scanner, wherein the current location of the scanner is used as a location of the asset identified by the asset identifier.

2. The method of claim 1, further comprising storing the asset identifier and a time and date of the scanning in the asset location record.

3. The method of claim 1, wherein the asset location record is stored in the scanner.

4. The method of claim 1, further comprising uploading the asset location record to a location management system.

5. The method of claim 1, wherein the scanning is performed on a plurality of asset labels each associated with a different asset.

6. The method of claim 1, wherein the asset is located in a storage area.

7. The method of claim 1, wherein the asset identifier uniquely identifies the asset among a plurality of other assets.

8. The method of claim 1, further comprising managing inventory according to the asset location record.

9. The method of claim 1, wherein the current location is determined using a global positioning system device.

10. The method of claim 1, wherein the current location is stored as a Cartesian coordinate within a storage area.

11. The method of claim 1, wherein the current location is determined using WiFi.

12. A scanner comprising:
at least one of a barcode reader and a radio frequency identification (RFID) scanner, configured to receive an asset identifier by scanning an asset label of an asset;
a locator configured to determine a current location of the scanner; and
a storage configured to store the asset identifier and the current location as an asset location record.

13. The scanner of claim 12, wherein the storage is also configured to store a time and date of the scanning in the asset location record.

14. The scanner of claim 12, wherein the scanner is configured to upload the asset location record to a location management system.

15. The scanner of claim 12, wherein the storage stores a plurality of asset location records each associated with a different asset.

16. The scanner of claim 12, wherein the scanner is an automated scanner that scans a plurality of assets in a storage area.

17. The scanner of claim 12, wherein the asset identifier uniquely identifies the asset among a plurality of other assets.

18. The scanner of claim 12, wherein the locator includes a global positioning system device.

19. The scanner of claim 12, wherein the current location is stored as a Cartesian coordinate within a storage area.

20. The scanner of claim 12, wherein the current location is determined using WiFi.
